(19) United States
(12) Patent Application Publication
(10) Pub. No.: US 2025/0219291 A1
(43) Pub. Date: Jul. 3, 2025

(54) ANTENNA AND CONTROL DEVICE

(71) Applicant: AUTEL ROBOTICS CO., LTD., Nanshan District (CN)

(72) Inventors: Jianping SONG, Nanshan District (CN); Zhixiang LI, Nanshan District (CN)

(21) Appl. No.: 19/004,281

(22) Filed: Dec. 28, 2024

(30) Foreign Application Priority Data
Dec. 29, 2023 (CN) 202311865438.1

(51) Int. Cl. H01Q 5/307; H01Q 1/42

(52) U.S. Cl. CPC H01Q 5/307; H01Q 1/42

(57) ABSTRACT

Disclosed are an antenna and a control device, which relate to the technical field of antennas. The antenna includes a housing and an antenna module, where the housing includes a radome and a reflecting bottom housing, and the radome and the reflecting bottom housing jointly form an accommodating cavity; and the antenna module is mounted in the accommodating cavity, the antenna module is configured to radiate an electromagnetic signal, and the reflecting bottom housing is configured to reflect the electromagnetic signal radiated by the antenna module, such that the electromagnetic signal radiates in a direction of the radome. Through the above method, a distance of radiating the electromagnetic signal by the antenna can be increased through embodiments of the disclosure.

### BACKGROUND

### Cross Reference

This application claims priority to and the benefit of Chinese Patent Application No. 202311865438.1, filed Dec. 29, 2023, the entirety of which is hereby incorporated herein by reference.

### Technical Field

Embodiments of the disclosure relate to the technical field of antennas, and particularly relate to an antenna and a control device.

### Related Art

At present, omnidirectional antennas are used in a wide range of control devices for controlling flight of an unmanned aerial vehicle to transmit or receive electromagnetic signals so as to control the flight of the unmanned aerial vehicle. However, the omnidirectional antennas are low in gain and short in transmission distance, thereby limiting a flight distance of the unmanned aerial vehicle.

### SUMMARY

A technical problem mainly to be solved by embodiments of the disclosure is to provide an antenna and a control device, which can increase a distance of radiating an electromagnetic signal by the antenna.

To solve the above technical problem, a technical solution used in an embodiment of the disclosure is as follows: an antenna is provided. The antenna includes a housing and an antenna module. The housing includes a radome and a reflecting bottom housing. The radome and the reflecting bottom housing jointly form an accommodating cavity. The antenna module is mounted in the accommodating cavity. The antenna module is configured to radiate an electromagnetic signal. The reflecting bottom housing is configured to reflect the electromagnetic signal radiated by the antenna module. Thus, the electromagnetic signal radiates in a direction of the radome. In the embodiment, the electromagnetic signal radiated by the antenna module is reflected by the reflecting bottom housing such that an intensity of an electromagnetic signal on one side of the radome can be enhanced. Further, a distance of transmitting, by the antenna, the electromagnetic signal on one side of the radome can be increased.

Optionally, the antenna module includes a first radiating assembly. The first radiating assembly includes a first dielectric plate, a first feed line, a first radiating arm, and a second radiating arm. The first dielectric plate is accommodated in the accommodating cavity. The first radiating arm and the second radiating arm are both arranged on the first dielectric plate. One end of the first radiating arm is electrically connected to an inner conductor of the first feed line. One end of the second radiating arm is electrically connected to an outer conductor of the first feed line. The other end of the second radiating arm extends in a direction away from the first radiating arm. The first radiating arm and the second radiating arm are jointly configured to radiate an electromagnetic signal in a first frequency band.

Optionally, the first radiating arm includes a first straight section and a first gradually-changing section, two ends of the first straight section are connected to the inner conductor of the first feed line and the first gradually-changing section respectively, a width of the first gradually-changing section gradually increases from one end of the first gradually-changing section close to the first straight section to one end away from the first straight section, and a length of the first radiating arm can be reduced by arranging the first gradually-changing section;
and/or
the second radiating arm includes a second straight section and a second gradually-changing section, two ends of the second straight section are connected to the outer conductor of the first feed line and the second gradually-changing section respectively, a width of the second gradually-changing section gradually increases from one end of the second gradually-changing section close to the second straight section to one end away from the second straight section, and a length of the second radiating arm can be reduced by arranging the second gradually-changing section.

Optionally, the first radiating assembly further includes a third radiating arm and a fourth radiating arm. The third radiating arm and the fourth radiating arm are both arranged on the first dielectric plate. One end of the third radiating arm is electrically connected to the inner conductor of the first feed line. One end of the fourth radiating arm is electrically connected to the outer conductor of the first feed line. The other end of the fourth radiating arm extends in a direction away from the third radiating arm. The third radiating arm and the fourth radiating arm are jointly configured to radiate an electromagnetic signal in a second frequency band. By arranging the third radiating arm and the fourth radiating arm, the antenna can radiate the electromagnetic signal in the second frequency band. Thus, electromagnetic signals in different frequency bands can be used in different environments, and application scenarios of the antenna can be expanded.

Optionally, the antenna module further includes a second radiating assembly and a power dividing assembly. The first feed line is connected to the power dividing assembly. The second radiating assembly includes a second dielectric plate, a second feed line, a fifth radiating arm, and a sixth radiating arm. The second dielectric plate is accommodated in the accommodating cavity. The fifth radiating arm and the sixth radiating arm are both arranged on the second dielectric plate. An outer conductor of the second feed line is connected to one end of the fifth radiating arm. An inner conductor of the second feed line is connected to one end of the sixth radiating arm. The second feed line is further connected to the power dividing assembly. The fifth radiating arm and the sixth radiating arm are jointly configured to radiate an electromagnetic signal in a third frequency band. By arranging the second radiating assembly, the antenna can further radiate the electromagnetic signal in the third frequency band, and usage scenarios of the antenna can be further expanded.

Optionally, the fifth radiating arm is in a T shape; and/or the sixth radiating arm is in a T shape. By setting the fifth radiating arm in the T shape, a length of the fifth radiating arm can be reduced. By setting the sixth radiating arm in the T shape, a length of the sixth radiating arm can be reduced.

Optionally, a plurality of fifth radiating arms are arranged. The plurality of fifth radiating arms are all arranged on a first surface of the second dielectric plate. The plurality of fifth radiating arms are all electrically connected to the outer conductor of the second feed line. The first surface faces the reflecting bottom housing. By arranging the plurality of fifth radiating arms, an intensity of the electromagnetic signal in the third frequency band can be improved, and a distance of radiating, by the antenna, the electromagnetic signal in the third frequency band can be increased.
And/or,
a plurality of sixth radiating arms are arranged. The plurality of sixth radiating arms are all arranged on a second surface of the second dielectric plate. The plurality of sixth radiating arms are all electrically connected to the inner conductor of the second feed line. The second surface faces away from the reflecting bottom housing. By arranging the plurality of sixth radiating arms, an intensity of the electromagnetic signal in the third frequency band can also be improved, and the distance of radiating, by the antenna, the electromagnetic signal in the third frequency band can be increased.

Optionally, the second radiating assembly further includes a first feed network and a second feed network. The first feed network is configured to be connected to the fifth radiating arm and the outer conductor of the second feed line. The second feed network is configured to be connected to the sixth radiating arm and the inner conductor of the second feed line. The first feed network is arranged on the first surface of the second dielectric plate. The second feed network is arranged on the second surface of the second dielectric plate. The first feed network and the second feed network at least partially overlap in a direction perpendicular to the first surface. The first surface faces the reflecting bottom housing. The second surface faces away from the reflecting bottom housing. By enabling the first feed network and the second feed network to at least partially overlap, a coupling effect can be formed between the first feed network and the second feed network, and the intensity of the electromagnetic signal in the third frequency band can be enhanced.

Optionally, the antenna module further includes a third radiating assembly. The third radiating assembly includes a third dielectric plate, a third feed line, a seventh radiating arm, and an eighth radiating arm. The third dielectric plate is accommodated in the accommodating cavity. The seventh radiating arm and the eighth radiating arm are both arranged on the dielectric plate. One end of the seventh radiating arm is electrically connected to an outer conductor of the third feed line. One end of the eighth radiating arm is electrically connected to an inner conductor of the third feed line. The third feed line is further connected to the power dividing assembly. The seventh radiating arm and the eighth radiating arm are jointly configured to radiate an electromagnetic signal in a fourth frequency band. By arranging the third radiating assembly to radiate the electromagnetic signal in the fourth frequency band, usage scenarios of the antenna can be further expanded.

Optionally, a plurality of seventh radiating arms are arranged. The plurality of seventh radiating arms are all arranged on a third surface of a third dielectric plate. The plurality of seventh radiating arms are all electrically connected to an outer conductor of a third feed line. The third surface faces the reflecting bottom housing. By arranging the plurality of seventh radiating arms, the intensity of the electromagnetic signal in the fourth frequency band can be enhanced.
And/or,
a plurality of eighth radiating arms are arranged. The plurality of eighth radiating arms are all arranged on a fourth surface of the third dielectric plate. The plurality of eighth radiating arms are all electrically connected to an inner conductor of the third feed line. The fourth surface faces away from the reflecting bottom housing. By arranging the plurality of eighth radiating arms, the intensity of the electromagnetic signal in the fourth frequency band can also be increased.

Optionally, the third radiating assembly further includes a third feed network and a fourth feed network. The third feed network is configured to be connected to the seventh radiating arm and the outer conductor of the second feed line. The fourth feed network is configured to be connected to the eighth radiating arm and the inner conductor of the second feed line. The third feed network is arranged on a third surface of a third dielectric plate. The fourth feed network is arranged on a fourth surface of the third dielectric plate. The third feed network and the fourth feed network at least partially overlap in a direction perpendicular to the third surface. The third surface faces the reflecting bottom housing. The fourth surface faces away from the reflecting bottom housing. By enabling the third feed network and the fourth feed network to at least partially overlap, a coupling effect can be formed between the third feed network and the fourth feed network, and the intensity of the electromagnetic signal in the fourth frequency band can be enhanced.

To solve the above technical problem, another technical solution used in an embodiment of the disclosure is as follows: a control device is provided. The control device includes a control body and the above antenna. A housing in the antenna is rotationally connected to the control body. The antenna further includes a feed bus. One end of the feed bus is connected to the antenna module. The other end of the feed bus is connected to the control body. The feed bus is configured to transmit an electromagnetic signal between the antenna module and the control body. In the embodiment, by rotationally connecting the housing in the antenna to the control body, the antenna can radiate electromagnetic signals in different directions by rotating the housing.

Optionally, the control device further includes a rotary seat. The rotary seat is mounted on the control body. The rotary seat is provided with a first rotary shaft and a second rotary shaft. The first rotary shaft and the second rotary shaft are opposite each other. The first rotary shaft and the second rotary shaft are inserted into the housing. The housing is capable of rotating around the first rotary shaft and the second rotary shaft. By arranging the first rotary shaft and the second rotary shaft, the housing rotates around the first rotary shaft and the second rotary shaft. Thus, a direction of radiating an electromagnetic signal by the antenna module can be adjusted.

Different from the prior art, embodiments of the disclosure have beneficial effects as follows: the antenna module is mounted in the accommodating cavity jointly formed by the radome and the reflecting bottom housing, and a signal is radiated in the direction of the radome by the reflecting bottom housing such that the intensity of the electromagnetic signal on one side of the radome can be enhanced, and the distance of radiating the electromagnetic signal can increased.

### BRIEF DESCRIPTION OF THE DRAWINGS

To more clearly illustrate technical solutions in embodiments of the disclosure or in the prior art, accompanying drawings required to be used in descriptions of particular embodiments or the prior art will be briefly introduced below. Similar elements or parts are generally identified by similar reference numerals throughout all accompanying drawings. In accompanying drawings, elements or parts are not certainly drawn to actual scale.

FIG. 1 is a schematic structural diagram of a control device according to an embodiment of the disclosure;

FIG. 2 is a first exploded view of a control device according to an embodiment of the disclosure;

FIG. 3 is a second exploded view of a control device according to an embodiment of the disclosure;

FIG. 4 is a first exploded view of an antenna according to an embodiment of the disclosure;

FIG. 5 is an enlarged view of an area shown in a portion A in FIG. 4;

FIG. 6 is an enlarged view of an area shown in a portion B in FIG. 4;

FIG. 7 is a second exploded view of an antenna according to an embodiment of the disclosure;

FIG. 8 is a schematic structural diagram of a first radiating assembly according to an embodiment of the disclosure;

FIG. 9 is a schematic structural diagram of a second radiating assembly in a first angle of view according to an embodiment of the disclosure;

FIG. 10 is an enlarged view of an area shown in a portion C in FIG. 9;

FIG. 11 is a schematic structural diagram of a second radiating assembly in a second angle of view according to an embodiment of the disclosure;

FIG. 12 is a schematic structural diagram of a third radiating assembly in a first angle of view according to an embodiment of the disclosure;

FIG. 13 is an enlarged view of an area shown in a portion D in FIG. 12;

FIG. 14 is an enlarged view of an area shown in a portion E in FIG. 12;

FIG. 15 is a schematic structural diagram of a third radiating assembly in a second angle of view;

FIG. 16 is a scatter (S) parameter diagram of an antenna in a first frequency band and a second frequency band according to an embodiment of the disclosure;

FIG. 17 is a directional pattern of an antenna in a first frequency band according to an embodiment of the disclosure;

FIG. 18 is a directional pattern of an antenna in a second frequency band according to an embodiment of the disclosure;

FIG. 19 is an S parameter diagram of an antenna in a third frequency band according to an embodiment of the disclosure;

FIG. 20 is a directional pattern of an antenna in a third frequency band according to an embodiment of the disclosure;

FIG. 21 is an S parameter diagram of an antenna in a fourth frequency band according to an embodiment of the disclosure; and

FIG. 22 is a directional pattern of an antenna in a fourth frequency band according to an embodiment of the disclosure.

### DETAILED DESCRIPTION

To facilitate understanding of the disclosure, the disclosure will be described in more detail below in combination with accompany drawings and particular embodiments. It should be noted that when an element is expressed to be “fixed” to another element, the element may be directly located on another element, or there may be one or more intermediate elements therebetween. When an element is expressed to be “connected” to another element, the element may be directly connected to another element, or there may be one or more intermediate elements therebetween. An orientation or positional relationship indicated by terms “upper”, “lower”, “inner”, “outer”, “perpendicular”, “horizontal”, etc. used in the description is an orientation or positional relationship shown based on accompanying drawings, is only for convenience of describing the disclosure and simplifying the description, rather than indicating or implying that the referred device or element must have a particular orientation, and be constructed and operated in a particular orientation, and thus cannot be construed as limiting the disclosure. In addition, terms “first”, “second”, etc. are merely for a descriptive purpose and cannot be construed as indicating or implying relative importance.

Unless otherwise defined, all technical and scientific terms used in the description have the same meaning as commonly understood by those skilled in the technical field of the disclosure. Terms used in the description of the disclosure are only for the purpose of describing particular embodiments, and are not intended to limit the disclosure. The term “and/or” used in the description includes any and all combinations of one or more related items listed.

In addition, the technical features involved in different embodiments of the disclosure described below can be combined with one another as long as the technical features do not constitute a conflict with one another.

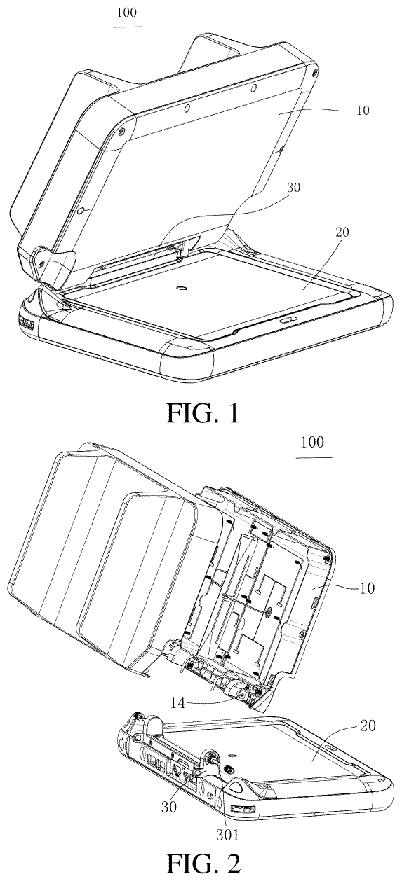

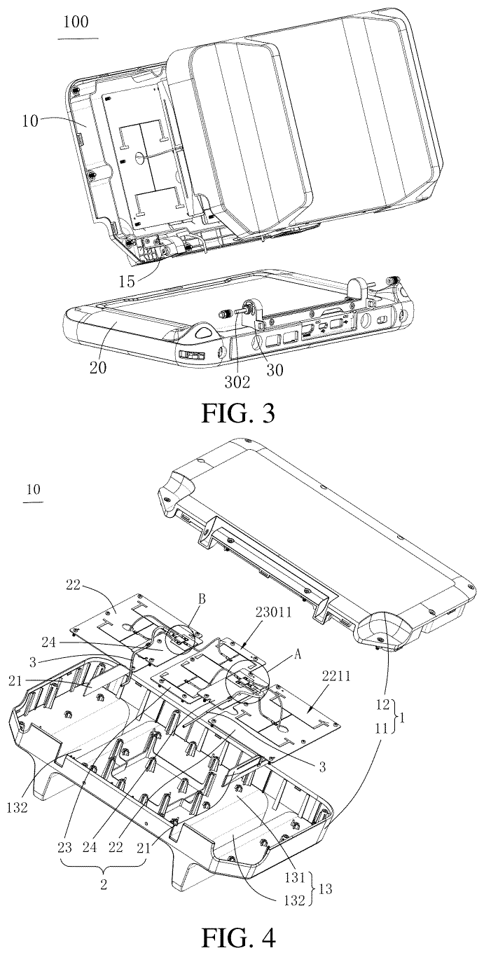

With reference to FIG. 1, FIG. 2, and FIG. 3, the above control device 100 includes an antenna 10, a control body 20, and a rotary seat 30. The rotary seat 30 is provided with a first rotary shaft 301 and a second rotary shaft 302. The first rotary shaft 301 and the second rotary shaft 302 are opposite each other. The first rotary shaft 301 and the second rotary shaft 302 are coaxially arranged. The rotary seat 30 is mounted to the control body 20. The antenna 10 is provided a first rotary hole 14 and a second rotary hole 15. The first rotary shaft 301 is rotationally arranged in the first rotary hole 14. The second rotary shaft 302 is rotationally arranged in the second rotary hole 15. Thus, the antenna 10 can rotate around the first rotary shaft 301 and the second rotary shaft 302. The antenna 10 can rotate around the first rotary shaft 301 and the second rotary shaft 302 to a position at which the antenna overlaps the control body 20. Thus, a space occupied by the control device 100 can be reduced when the control device 100 is stored. The control body 20 is further connected to the antenna 10. The control body 20 may transmit a control command in a form of an electromagnetic signal to the antenna 10. The antenna 10 can radiate the electromagnetic signal to the outside such that an unmanned aerial vehicle (not shown in the figures) can receive the control command sent by the control body 20 and complete a corresponding flight action according to the command. The antenna 10 may further receive an electromagnetic signal fed back by the unmanned aerial vehicle and transmit the electromagnetic signal fed back to the control body 20. Thus, the control body 20 can obtain flight information of the unmanned aerial vehicle.

In a case of the above antenna 10, with reference to FIG. 2 to FIG. 4, the antenna 10 includes a housing 1, an antenna module 2, and a feed bus 3. The first rotary hole 14 and the second rotary hole 15 are both provided in the housing 1. The antenna module 2 is mounted in the housing 1. One end of the feed bus 3 is connected to the antenna module 2. The other end of the feed bus 3 is configured to be connected to the control body 20. The feed bus 3 is configured to transmit an electromagnetic signal between the antenna module 2 and the control body 20. The antenna module 2 is configured to radiate the electromagnetic signal.

In a case of the above housing 1, with reference to FIG. 4, the housing 1 includes a radome 11 and a reflecting bottom housing 12. The radome 11 and the reflecting bottom housing 12 jointly form an accommodating cavity 13. The antenna module 2 is mounted in the accommodating cavity 13. The reflecting bottom housing 12 is configured to reflect an electromagnetic signal radiated by the antenna module 2. When the antenna module 2 radiates electromagnetic signals, the electromagnetic signals radiate in a plurality of directions by taking the antenna module 2 as a center. The electromagnetic signals radiating toward the reflecting bottom housing 12 are reflected by the reflecting bottom housing 12 and then radiate in a direction of the radome 11 such that the electromagnetic signals radiated by the antenna module 2 can collectively radiate in a direction of the radome 11 facing away from the reflecting bottom housing 12. An intensity of the electromagnetic signals radiating in the direction of the radome 11 facing away from the reflecting bottom housing 12 is greatly enhanced. Moreover, a distance of radiating the electromagnetic signals can be extended. When the antenna 10 is applied to the control device 100 of the unmanned aerial vehicle, since the radiation distance of the antenna 10 is extended, a flight distance of the unmanned aerial vehicle can be increased.

It is worth noting that the reflecting bottom housing 12 is made of a metal material, such as copper, aluminum, and nickel; or a surface of the reflecting bottom housing 12 facing the radome 11 is coated with a metal layer; or the surface of the reflecting bottom housing 12 facing away from the radome 11 is coated with a metal layer. Thus, the reflecting bottom housing 12 can reflect the electromagnetic signal.

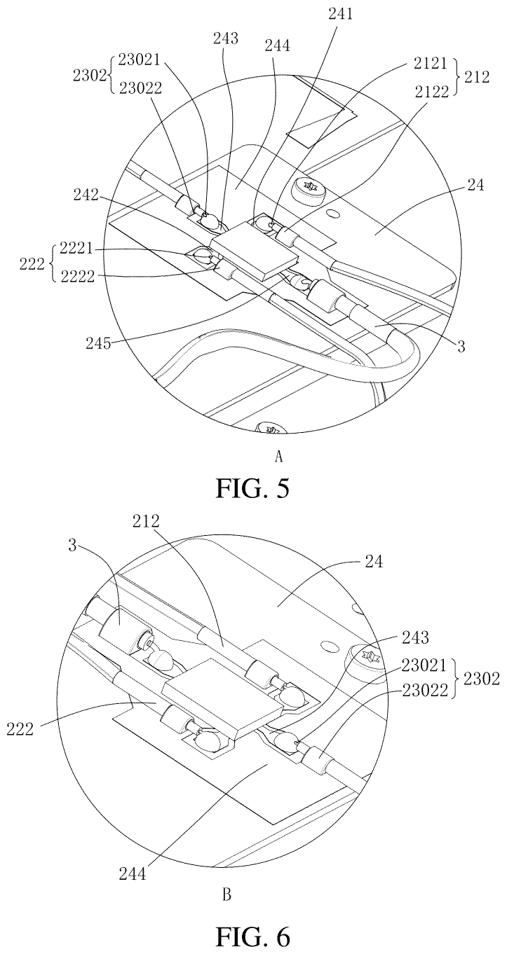

In a case of the above antenna module 2, with reference to FIG. 3, FIG. 4, and FIG. 5, the antenna module 2 includes a first radiating assembly 21, a second radiating assembly 22, a third radiating assembly 23, and a power dividing assembly 24. The accommodating cavity 13 includes a first cavity 131 and a second cavity 132 which are in communication with each other. The first radiating assembly 21 is accommodated in the second cavity 132. The second radiating assembly 22, the third radiating assembly 23, and the power dividing assembly 24 are all accommodated in the first cavity 131. Moreover, the first radiating assembly 21 is substantially perpendicular to the second radiating assembly 22. The third radiating assembly 23 is substantially parallel to the second radiating assembly 22. The power dividing assembly 24 is provided with a first output terminal 241, a second output terminal 242, a third output terminal 243, and an access terminal 245. One end of the feed bus 3 is electrically connected to the power dividing assembly 24. The other end of the feed bus 3 is electrically connected to the control body 20. An electromagnetic signal is transmitted between the power dividing assembly 24 and the control body 20 by the feed bus 3. The first radiating assembly 21 is electrically connected to the first output terminal 241. The second radiating assembly 22 is electrically connected to the second output terminal 242. The third radiating assembly 23 is electrically connected to the third output terminal 243. The first radiating assembly 21 is configured to radiate an electromagnetic signal in a first frequency band and an electromagnetic signal in a second frequency band. The second radiating assembly 22 is configured to radiate an electromagnetic signal in a third frequency band. The third radiating assembly 23 is configured to radiate an electromagnetic signal in a fourth frequency band. The power dividing assembly 24 is configured to distribute the electromagnetic signals to the first radiating assembly 21, the second radiating assembly 22, and the third radiating assembly 23. The first frequency band, the second frequency band, the third frequency band, and the fourth frequency band are different from one another. Specifically, the power dividing assembly 24 is configured to distribute electromagnetic signals in the first frequency band and electromagnetic signals in the second frequency band to the first radiating assembly 21 for radiation, distribute electromagnetic signals in the third frequency band to the second radiating assembly 22 for radiation, and distribute electromagnetic signals in the fourth frequency band to the third radiating assembly 23 for radiation. Since electromagnetic signals in different frequency bands are required to be used to work in different environments, in the embodiment, the electromagnetic signal in the first frequency band and the electromagnetic signal in the second frequency band are radiated by the first radiating assembly 21. The electromagnetic signal in the third frequency band is radiated by the second radiating assembly 22. The electromagnetic signal in the fourth frequency band is radiated by the third radiating assembly 23. Thus, the antenna 10 can work in various environments, and application ranges of the antenna 10 can be expanded.

It is worth noting that the power dividing assembly 24 is a triplexer.

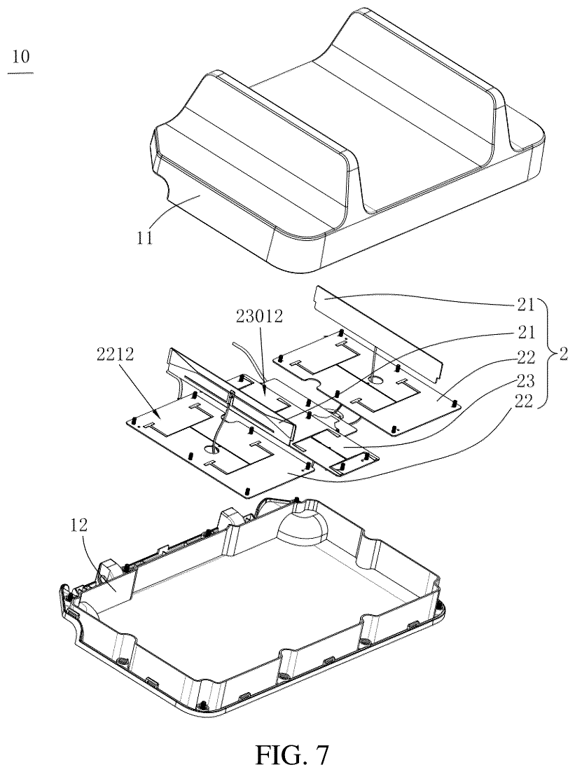

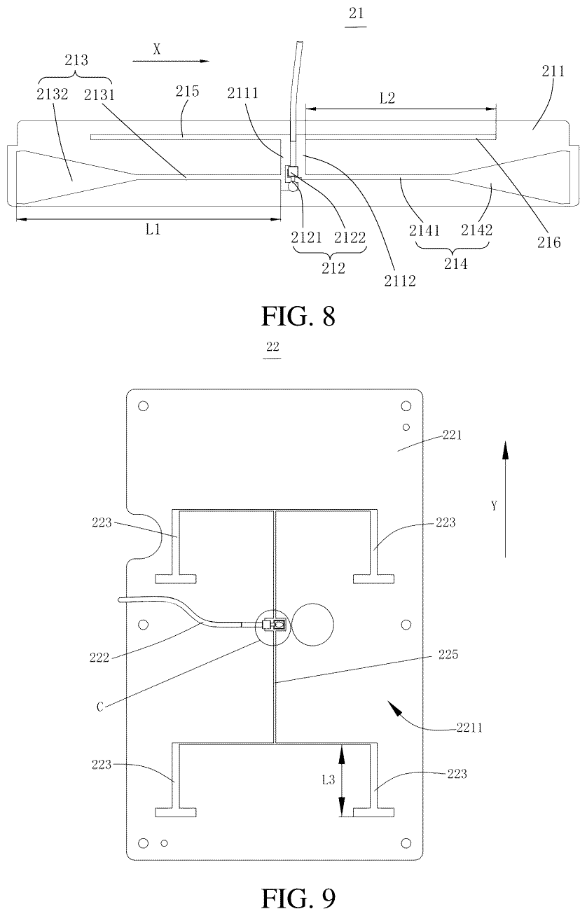

In a case of the above first radiating assembly 21, with reference to FIG. 5, FIG. 7, and FIG. 8, the first radiating assembly 21 includes a first dielectric plate 211, a first feed line 212, a first radiating arm 213, a second radiating arm 214, a third radiating arm 215, and a fourth radiating arm 216. The first dielectric plate 211 is mounted in the second cavity 132 of the accommodating cavity 13. The first dielectric plate 211 is provided with a first feed portion 2111 and a second feed portion 2112. The first feed portion 2111 and the second feed portion 2112 are independent from each other. One end of the first radiating arm 213 is electrically connected to the first feed portion 2111. The other end of the first radiating arm 213 extends in a direction away from the second feed portion 2112. One end of the second radiating arm is electrically connected to the second feed portion 2112. The other end of the second radiating arm 214 extends in a direction away from the first feed portion 2111. The first radiating arm 213 and the second radiating arm 214 are jointly configured to radiate an electromagnetic signal in the first frequency band. One end of the third radiating arm 215 is electrically connected to the first feed portion 2111. The other end of the third radiating arm 215 extends in a direction away from the second feed portion 2112. The third radiating arm 215 and the first radiating arm 213 are distributed at an interval. One end of the fourth radiating arm 216 is electrically connected to the second feed portion 2112. The other end of the fourth radiating arm 216 extends in a direction away from the first feed portion 2111. The fourth radiating arm 216 and the second radiating arm 214 are distributed at an interval. The third radiating arm 215 and the fourth radiating arm 216 are jointly configured to radiate an electromagnetic signal in the second frequency band. The inner conductor 2121 of the first feed line 212 is electrically connected to the first feed portion 2111. The outer conductor 2122 of the first feed line 212 is electrically connected to the second feed portion 2112. The inner conductor 2121 of the first feed line 212 and the outer conductor 2122 of the first feed line 212 are insulated from each other. The power dividing assembly 24 is further provided with a radio frequency ground 244. The radio frequency ground 244 is spaced apart from the first output terminal 241, the second output terminal 242, the third output terminal 243, and the access terminal 245, such that the radio frequency ground 244 is electrically insulated from the first output terminal 241, the second output terminal 242, the third output terminal 243, and the access terminal 245. The inner conductor 2121 of the first feed line 212 is electrically connected to the first output terminal 241. The outer conductor 2122 of the first feed line 212 is electrically connected to the radio frequency ground 244. Thus, a signal can be transmitted between the first radiating assembly 21 and the power dividing assembly 24 by the first feed line 212.

It is worth noting that the electromagnetic signal in the first frequency band has a frequency greater than or equal to 0.82 GHz and less than or equal to 0.86 GHz. The electromagnetic signal in the second frequency band has a frequency greater than or equal to 1.28 GHz and less than or equal to 1.36 GHz.

Further, with reference to FIG. 8, in a first direction X, a length L1 of the first radiating arm 213 is greater than or equal to ⅛ of a wavelength of the electromagnetic signal in the first frequency band and less than or equal to ¾ of the wavelength of the electromagnetic signal in the first frequency band. Specifically, in a case that computation is performed with an intermediate frequency of the electromagnetic signal in the first frequency band as 0.84 GHz, the length L1 of the first radiating arm 213 satisfies the following: 44.64 mm≤L1≤267.86 mm.

Further, in the first direction X, the first radiating arm 213 and the second radiating arm 214 are symmetrical with respect to each other.

In some embodiments, with reference to FIG. 8, the first radiating arm 213 includes a first straight section 2131 and a first gradually-changing section 2132. One end of the first straight section 2131 is electrically connected to the first feed portion 2111. The first gradually-changing section 2132 is connected to the other end of the first straight section 2131. Moreover, a width of the first gradually-changing section 2132 gradually increases from one end of the first gradually-changing section 2132 close to the first straight section 2131 to one end away from the first straight section 2131. In the embodiment, by arranging the first gradually-changing section 2132, the length of the first radiating arm 213 in the first direction X can be reduced such that the length of the antenna 10 in the first direction X can be reduced. In addition, by arranging the first gradually-changing section 2132, a frequency bandwidth of the electromagnetic signal in the first frequency band can be increased.

In some embodiments, with reference to FIG. 8, the second radiating arm 214 includes a second straight section 2141 and a second gradually-changing section 2142. One end of the second straight section 2141 is electrically connected to the second feed portion 2112. The second gradually-changing section 2142 is connected to the other end of the second straight section 2141. Moreover, a width of the second gradually-changing section 2142 gradually increases from one end of the second gradually-changing section 2142 close to the second straight section 2141 to one end away from the second straight section 2141. In the embodiment, by arranging the second gradually-changing section 2142, the length of the second radiating arm 214 in the first direction X can be reduced such that the length of the antenna 10 in the first direction X can be reduced. In addition, by arranging the second gradually-changing section 2142, a frequency bandwidth of the electromagnetic signal in the first frequency band can be increased.

In some embodiments, with reference to FIG. 8, in the first direction X, a length L2 of the third radiating arm 215 is greater than or equal to ⅛ a wavelength of the electromagnetic signal in the second frequency band and less than or equal to ¾ of the wavelength of the electromagnetic signal in the second frequency band. Specifically, in a case that computation is performed with an intermediate frequency of the electromagnetic signal in the second frequency band as 1.32 GHz, the length L2 of the third radiating arm 215 satisfies the following: 28.41 mm≤L2≤170.45 mm.

Further, with reference to FIG. 8, in the first direction X, the fourth radiating arm 216 and the third radiating arm 215 are symmetrical with respect to each other.

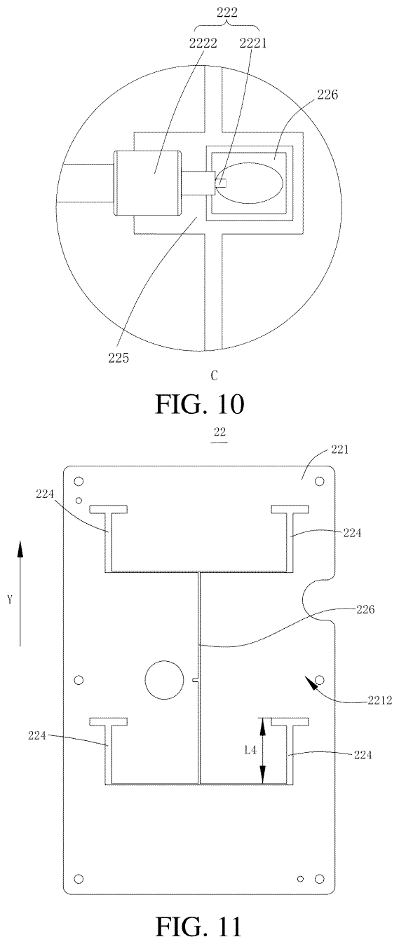

In a case of the above second radiating assembly 22, with reference to FIG. 4, FIG. 5, FIG. 9, FIG. 10, and FIG. 11, the second radiating assembly 22 includes a second dielectric plate 221, a second feed line 222, a fifth radiating arm 223, and a sixth radiating arm 224. The second dielectric plate 221 is mounted in the first cavity 131 of the accommodating cavity 13. The second dielectric plate 221 is substantially perpendicular to the first dielectric plate 211. The fifth radiating arm 223 is mounted on a first surface 2211 of the second dielectric plate 221. The first surface 2211 faces away from the first dielectric plate 211. The sixth radiating arm 224 is mounted on a second surface 2212 of the second dielectric plate 221. The first surface 2211 and the second surface 2212 are opposite each other. The fifth radiating arm 223 and the sixth radiating arm 224 are jointly configured to radiate an electromagnetic signal in a third frequency band. In a direction perpendicular to the first surface 2211, projections of the fifth radiating arm 223 and the sixth radiating arm 224 do not overlap such that interference between the fifth radiating arm 223 and the sixth radiating arm 224 can be reduced. One end of the fifth radiating arm 223 is electrically connected to the outer conductor 2222 of the second feed line 222. One end of the sixth radiating arm 224 is electrically connected to the inner conductor 2221 of the second feed line 222. The inner conductor 2221 of the second feed line 222 is further electrically connected to the second output terminal 242 of the power dividing assembly 24. The outer conductor 2222 of the second feed line 222 is further electrically connected to the radio frequency ground 244 of the power dividing assembly 24. Thus, the second feed line 222 can transmit a signal between the power dividing assembly 24, the fifth radiating arm 223, and the sixth radiating arm 224.

It is worth noting that a frequency of the electromagnetic signal in the third frequency band is greater than or equal to 2.12 GHz and less than or equal to 2.75 GHz.

In some embodiments, with reference to FIG. 9, the fifth radiating arm 223 is in a T shape. By setting the fifth radiating arm 223 in the T shape, a length of the fifth radiating arm 223 in the second direction Y can be reduced, and the size of the antenna 10 can be reduced.

Further, with reference to FIG. 9, the length L3 of the fifth radiating arm 223 in the second direction Y is greater than or equal to ⅛ of a wavelength of the electromagnetic signal in the third frequency band and less than or equal to ¾ of the wavelength of the electromagnetic signal in the third frequency band. Specifically, in a case that computation is performed with an intermediate frequency of the electromagnetic signal in the third frequency band as 2.435 GHz, the length L3 of the fifth radiating arm 223 in the second direction Y satisfies the following: 15.40 mm≤L3≤92.40 mm.

In some embodiments, a plurality of fifth radiating arms 223 are arranged. The plurality of fifth radiating arms 223 are all arranged on the first surface 2211 of the second dielectric plate 221. The plurality of fifth radiating arms 223 are distributed in a rectangular shape. One end of each of the fifth radiating arms 223 is electrically connected to the outer conductor 2222 of the second feed line 222. In the embodiment, by arranging the plurality of fifth radiating arms 223, an intensity of radiating, by the antenna 10, the electromagnetic signal in the third frequency band can be enhanced.

In some embodiments, with reference to FIG. 11, the sixth radiating arm 224 is in a T shape. By setting the sixth radiating arm 224 in the T shape, a length of the sixth radiating arm 224 in the second direction Y can be reduced, and the size of the antenna 10 can be reduced.

Further, with reference to FIG. 11, the length L4 of the sixth radiating arm 224 in the second direction Y is greater than or equal to ⅛ of a wavelength of the electromagnetic signal in the third frequency band and less than or equal to ¾ of the wavelength of the electromagnetic signal in the third frequency band. Specifically, in a case that computation is performed with an intermediate frequency of the electromagnetic signal in the third frequency band as 2.435 GHz, the length L4 of the sixth radiating arm 224 in the second direction Y satisfies the following: 15.40 mm≤L4≤92.40 mm.

In some embodiments, a plurality of sixth radiating arms 224 are arranged. The plurality of sixth radiating arms 224 are all arranged on the second surface 2212 of the second dielectric plate 221. The plurality of sixth radiating arms 224 are distributed in a rectangular shape. One end of each of the sixth radiating arms 224 is electrically connected to the inner conductor 2221 of the second feed line 222. In a direction perpendicular to the first surface 2211, projections of the plurality of fifth radiating arms 223 and the plurality of sixth radiating arms 224 do not overlap. Thus, interference generated between the plurality of fifth radiating arms 223 and the plurality of sixth radiating arms 224 can be reduced. In the embodiment, by arranging the plurality of sixth radiating arms 224, the intensity of radiating, by the antenna 10, the electromagnetic signal in the third frequency band can be enhanced.

In some embodiments, with reference to FIG. 9, FIG. 10, and FIG. 11, the second radiating assembly 22 further includes a first feed network 225 and a second feed network 226. The first feed network 225 is arranged on the first surface 2211 of the second dielectric plate 221. One end of each of the plurality of fifth radiating arms 223 is connected to the first feed network 225. The outer conductor 222 of the second feed line 222 is connected to the first feed network 225. Electromagnetic signals are transmitted between the plurality of fifth radiating arms 223 and the outer conductor 222 of the second feed line 222 by the first feed network 225. The second feed network 226 is arranged on the second surface 2212 of the second dielectric plate 221. Part of the second feed network 226 passes through the second dielectric plate 221 such that the part of the second feed network 226 can be exposed to the first surface 2211. The inner conductor 2221 of the second feed line 222 is connected to the part of the second feed network 226 exposed to the first surface 2211. The plurality of sixth radiating arms 224 are all connected to the second feed network 226. Electromagnetic signals are transmitted between the inner conductor 2221 of the second feed line 222 and the plurality of sixth radiating arms 224 by the second feed network 226. In a direction perpendicular to the first surface 2211, the first feed network 225 and the second feed network 226 partially overlap and partially do not overlap, thereby performing impedance matching to improve radiation efficiency in the third frequency band.

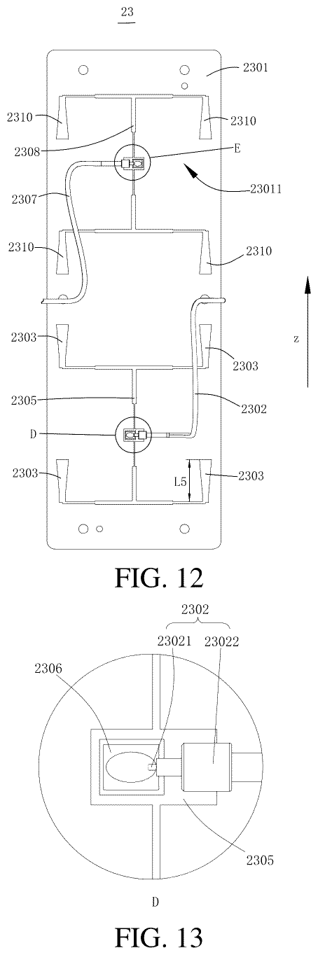

In a case of the above third radiating assembly 23, with reference to FIG. 4, FIG. 5, FIG. 12, FIG. 13, and FIG. 15, the third radiating assembly 23 includes a third dielectric plate 2301, a third feed line 2302, a seventh radiating arm 2303, and an eighth radiating arm 2304. The third dielectric plate 2301 is accommodated in the first cavity 131. Moreover, the third dielectric plate 2301 is substantially parallel to the second dielectric plate 221. The seventh radiating arm 2303 is arranged on a third surface 23011 of the third dielectric plate 2301. The third surface 23011 of the third dielectric plate 2301 faces the reflecting bottom housing 12. One end of the seventh radiating arm 2303 is electrically connected to the outer conductor 23022 of the third feed line 2302. The eighth radiating arm 2304 is arranged on a fourth surface 23012 of the third dielectric plate 2301. One end of the eighth radiating arm 2304 is electrically connected to the inner conductor 23021 of the third feed line 2302. The third surface 23011 and the fourth surface 23012 are opposite each other. The seventh radiating arm 2303 and the eighth radiating arm 2304 are jointly configured to radiate an electromagnetic signal in a fourth frequency band. The inner conductor 23021 of the third feed line 2302 is further electrically connected to the third output terminal 243 of the power dividing assembly 24. The outer conductor 23022 of the third feed line 2302 is further electrically connected to the radio frequency ground 244 of the power dividing assembly 24. Thus, electromagnetic signals can be transmitted between the power dividing assembly 24 and the seventh radiating arm 2303 and the eighth radiating arm 2304 by the third feed line 2302.

It is worth noting that the frequency of the electromagnetic signal in the fourth frequency band is greater than or equal to 4.80 GHz and less than or equal to 6.09 GHz.

In some embodiments, with reference to FIG. 12, in a third direction Z, a width of the seventh radiating arm 2303 gradually increases such that the length of the seventh radiating arm 2303 in the third direction Z can be reduced.

Further, with reference to FIG. 12, the length L5 of the seventh radiating arm 2303 in the third direction Z is greater than or equal to ⅛ of a wavelength of the electromagnetic signal in the fourth frequency band and less than or equal to ¾ of the wavelength of the electromagnetic signal in the fourth frequency band. Specifically, in a case that computation is performed with an intermediate frequency of the electromagnetic signal in the fourth frequency band as 5.445 GHz, the length L5 of the seventh radiating arm 2303 in the third direction Z satisfies the following: 6.89 mm≤L5≤41.32 mm.

In some embodiments, a plurality of seventh radiating arms 2303 are arranged. The plurality of seventh radiating arms 2303 are all arranged on the third surface 23011 of the third dielectric plate 2301. The plurality of seventh radiating arms 2303 are distributed in a rectangular shape. One end of each of the plurality of seventh radiating arms 2303 is electrically connected to the outer conductor 23022 of the third feed line 2302. In the embodiment, by arranging the plurality of seventh radiating arms 2303, the intensity of radiating, by the antenna 10, the electromagnetic signal in the fourth frequency band can be enhanced.

Further, with reference to FIG. 15, the length L6 of the eighth radiating arm 2304 in the third direction Z is greater than or equal to ⅛ of a wavelength of the electromagnetic signal in the fourth frequency band and less than or equal to ¾ of the wavelength of the electromagnetic signal in the fourth frequency band. Specifically, in a case that computation is performed with an intermediate frequency of the electromagnetic signal in the fourth frequency band as 5.445 GHz, the length L6 of the eighth radiating arm 2304 in the third direction Z satisfies the following: 6.89 mm≤L6≤41.32 mm.

In some embodiments, a plurality of eighth radiating arms 2304 are arranged. The plurality of eighth radiating arms 2304 are all arranged on the fourth surface 23012 of the third dielectric plate 2301. The plurality of eighth radiating arms 2304 are distributed in a rectangular shape. One end of each of the eighth radiating arms 2304 is electrically connected to the inner conductor 2221 of the third feed line 2302. In a direction perpendicular to the third surface 23011, projections of the plurality of seventh radiating arms 2303 and the plurality of eighth radiating arms 2304 do not overlap. Thus, interference generated between the plurality of seven radiating arms 2303 and the plurality of eighth radiating arms 2304 can be reduced. In the embodiment, by arranging the plurality of eighth radiating arms 2304, the intensity of radiating, by the antenna 10, the electromagnetic signal in the fourth frequency band can be enhanced.

In some embodiments, with reference to FIG. 12, FIG. 13, and FIG. 15, the third radiating assembly 23 further includes a third feed network 2305 and a fourth feed network 2306. The third feed network 2305 is arranged on the third surface 23011 of the third dielectric plate 2301. One end of each of the plurality of seventh radiating arms 2303 is connected to the third feed network 2305. The outer conductor 23022 of the third feed line 2302 is connected to the third feed network 2305. Electromagnetic signals are transmitted between the plurality of seventh radiating arms 2303 and the outer conductor 23022 of the third feed line 2302 by the third feed network 2305. The fourth feed network 2306 is arranged on the fourth surface 23012 of the third dielectric plate 2301. Part of the fourth feed network 2306 passes through the third dielectric plate 2301 such that the part of the fourth feed network 2306 can be exposed to the third surface 23011. The inner conductor 2221 of the third feed line 2302 is connected to the part of the fourth feed network 2306 exposed to the third surface 23011. The plurality of eighth radiating arms 2304 are all connected to the fourth feed network 2306. Electromagnetic signals are transmitted between the inner conductor 2221 of the third feed line 2302 and the plurality of eighth radiating arms 2304 by the fourth feed network 2306. In a direction perpendicular to the third surface 23011, the third feed network 2305 and the fourth feed network 2306 are composed of copper clad wires having different thicknesses and do not completely overlap, thereby performing impedance matching to improve radiation efficiency in the fourth frequency band.

In some embodiments, with reference to FIG. 4, FIG. 5, and FIG. 6, two first radiating assemblies 21, two power dividing assemblies 24, and two feed buses 3 are arranged. The two first radiating assemblies 21 and the two power dividing assemblies 24 have the same structure and function. Two second cavities 132 are arranged. The two second cavities 132 are in communication with the first cavity 131. Moreover, the two second cavities 132 are parallel to each other. The two first radiating assemblies 21 are accommodated in the two second cavities 132 respectively. Moreover, the two first radiating assemblies 21 are opposite each other. One end of each of the two feed buses 3 is electrically connected to the control body 20. The other end of each of the two feed buses 3 is connected to access terminals 245 of the two power dividing assemblies 24. One first radiating assembly 21 is connected to a first output terminal 241 of one power dividing assembly 24. The other first radiating assembly 21 is connected to a first output terminal 241 of the other power dividing assembly 24. The two first radiating assemblies 21 are both configured to radiate the electromagnetic signal in the first frequency band and the electromagnetic signal in the second frequency band. The two power dividing assemblies 24 are configured to distribute the electromagnetic signal in the first frequency band and the electromagnetic signal in the second frequency band to the first radiating assemblies 21 connected to the power dividing assemblies respectively. In the embodiment, two first radiating assemblies 21 are arranged, and the two first radiating assemblies 21 are both configured to radiate the electromagnetic signal in the first frequency band and the electromagnetic signal in the second frequency band. When one first radiating assembly 21 fails or a signal is extremely weak, the other first radiating assembly 21 can be used to work such that reliability of the antenna 10 in the first frequency band and the second frequency band can be improved. In addition, since positions of the two first radiating assemblies 21 in the accommodating cavity 13 are different, and directions of the electromagnetic signals radiated by the two first radiating assemblies are slightly different, a signal of one first radiating assembly 21 is stronger and a signal of the other first radiating assembly is weaker at some angles. In this case, the first radiating assembly 21 having a stronger signal can be selected to work such that the two first radiating assemblies 21 can be complementary, and the reliability of the antenna 10 in the first frequency band and the second frequency band can be improved.

Further, with reference to FIG. 4, FIG. 5, and FIG. 6, two second radiating assemblies 22 are arranged. The two second radiating assemblies 22 are both accommodated in the first cavity 131. The third radiating assembly 23 is located between the two second radiating assemblies 22. The two second radiating assemblies 22 have the same structure and function. That is, the two second radiating assemblies 22 are both configured to radiate electromagnetic signals in the third frequency band. A second output terminal 242 of one power dividing assembly 24 is connected to one second radiating assembly 22. A second output terminal 242 of the other power dividing assembly 24 is connected to the other second radiating assembly 22. The two power dividing assemblies 24 are further configured to distribute electromagnetic signals in the third frequency band to the second radiating assemblies 22 connected to the power dividing assemblies. In the embodiment, two second radiating assemblies 22 are arranged, and the two second radiating assemblies 22 are both configured to radiate the electromagnetic signal in the third frequency band. When one second radiating assembly 22 fails or a signal is extremely weak, the other second radiating assembly 22 can be used to work such that reliability of the antenna 10 in the first frequency band and the second frequency band can be improved. In addition, since positions of the two second radiating assemblies 22 in the accommodating cavity 13 are different, and directions of the electromagnetic signals radiated by the two first radiating assemblies are slightly different, a signal of one second radiating assembly 22 is stronger and a signal of the other second radiating assembly is weaker at some angles. In this case, the second radiating assembly 22 having a stronger signal can be selected to work such that the two second radiating assemblies 22 can be complementary, and the reliability of the antenna 10 in the first frequency band and the second frequency band can be improved.

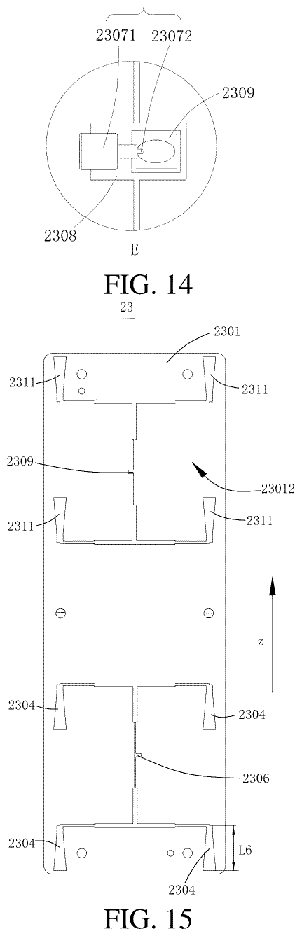

Further, with reference to FIG. 4, FIG. 5, FIG. 6, FIG. 12, FIG. 13, FIG. 14, and FIG. 15, the third feed network 2305 is electrically connected to one power dividing assembly 24 by the outer conductor 23021 of the third feed line 2302. The fourth feed network 2306 is electrically connected to one power dividing assembly 24 by the inner conductor 23022 of the third feed line 2302. The third radiating assembly 23 further includes a fourth feed line 2307, a fifth feed network 2308, a sixth feed network 2309, a plurality of ninth radiating arms 2310, and a plurality of tenth radiating arms 2311. The fifth feed network 2308 and the plurality of ninth radiating arms 2310 are all arranged on the third surface 23011 of the third dielectric plate 2301. One end of each of the plurality of ninth radiating arms 2310 is electrically connected to the fifth feed network 2308. The outer conductor 23071 of the fourth feed line 2307 is electrically connected to the fifth feed network 2308. The sixth feed network 2309 and the plurality of tenth radiating arms 2311 are all arranged on the fourth surface 23012 of the third dielectric plate 2301. One end of each of the plurality of tenth radiating arms 2311 is electrically connected to the sixth feed network 2309. Part of the sixth feed network 2309 passes through the third dielectric plate 2301 such that the part of the sixth feed network 2309 can be exposed to the third surface 23011. The inner conductor 23072 of the fourth feed line 2307 is electrically connected to the part of the sixth feed network 2309 exposed to the third surface 23011. The inner conductor 23072 of the fourth feed line 2307 is further electrically connected to the third output terminal 243 of the other power dividing assembly 24. The outer conductor 23071 of the fourth feed line 2307 is further electrically connected to a radio frequency ground 244 of the other power dividing assembly 24. Thus, the fourth feed line 2307 transmits signals between the other power dividing assembly 24 and the plurality of ninth radiating arms 2310 and the plurality of tenth radiating arms 2311. The plurality of ninth radiating arms 2310 and the plurality of tenth radiating arms 2311 are jointly configured to radiate the electromagnetic signal in the fourth frequency band. In the embodiment, by arranging the plurality of ninth radiating arms 2310 and the plurality of tenth radiating arms 2311 to jointly radiate the electromagnetic signal in the fourth frequency band, when the seventh radiating arm 2303 and the eighth radiating arm 2304 fail or signals are extremely weak, the ninth radiating arm 2310 and the tenth radiating arm 2311 can be selected to work, to improve working stability of the antenna 10 in the fourth frequency band.

Thus, the intensity of the electromagnetic signal in the fourth frequency band can be further enhanced, and the distance of radiating the electromagnetic signal in the fourth frequency band can be increased.

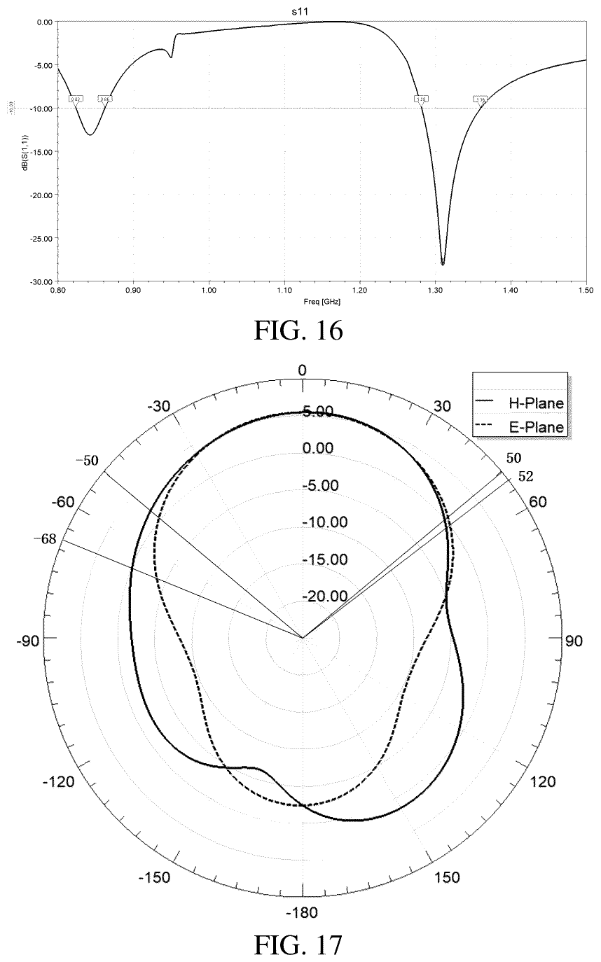

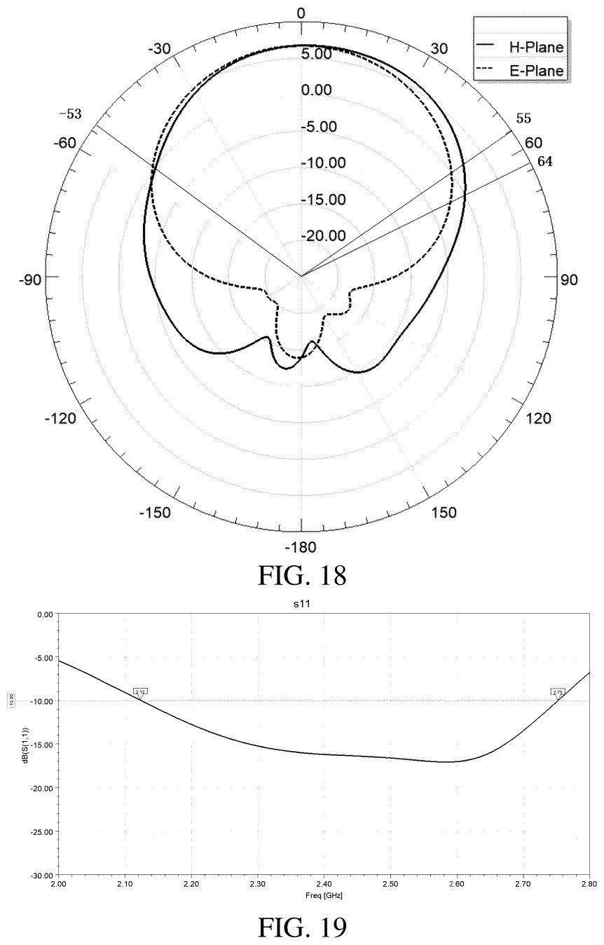

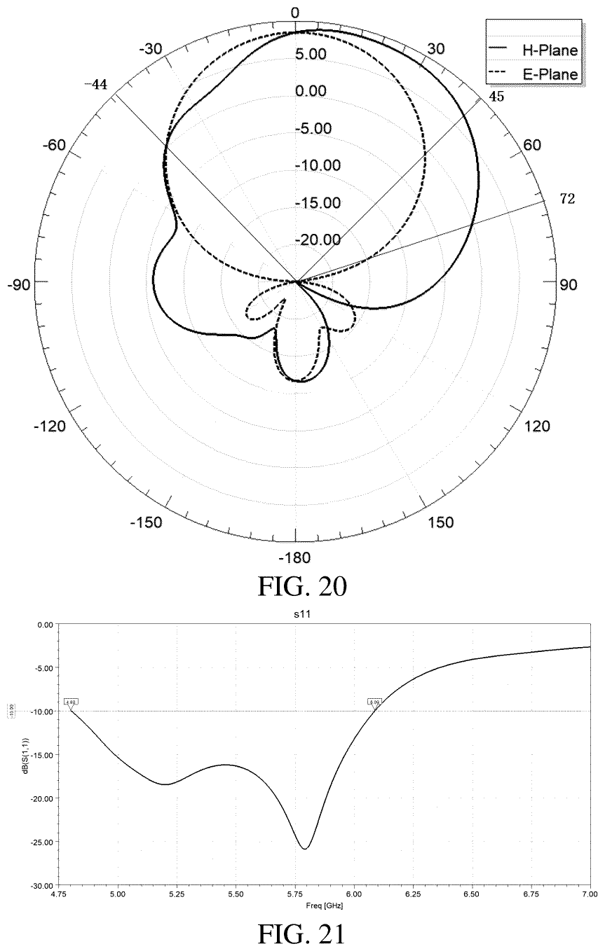

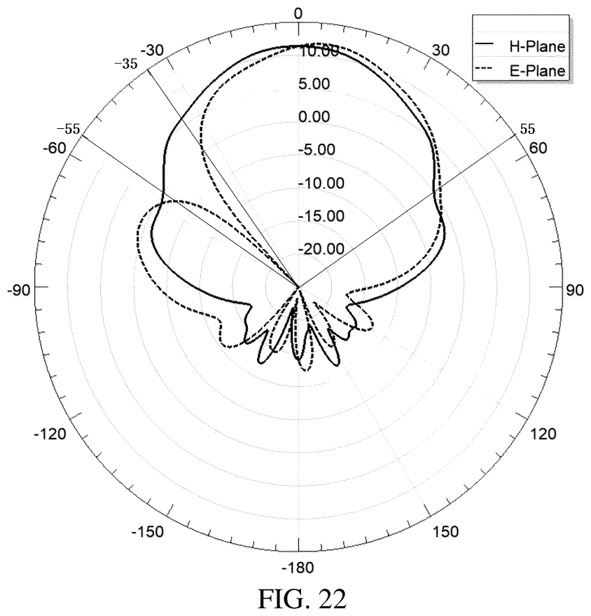

To enable a reader to better understand a concept of the disclosure, the antenna 10 will be experimentally demonstrated as follows:
1) In cases of the first frequency band and the second frequency band, the first radiating assembly 21 is arranged. The first radiating assembly 21 includes a first dielectric plate 211, a first feed line 212, a first radiating arm 213, a second radiating arm 214, a third radiating arm 215, and a fourth radiating arm 216. The first radiating arm 213, the second radiating arm 214, the third radiating arm 215, and the fourth radiating arm 216 are all arranged on the first dielectric plate 211. The first radiating arm 213 and the third radiating arm 215 are both connected to the power dividing assembly 24 by the inner conductor 2121 of the first feed line 212. The second radiating arm 214 and the fourth radiating arm 216 are both connected to the power dividing assembly 24 by the outer conductor of the first feed line 212. Thus, the first radiating arm 213 and the second radiating arm 214 can jointly radiate an electromagnetic signal in the first frequency band. The third radiating arm 215 and the fourth radiating arm 216 can jointly radiate an electromagnetic signal in the second frequency band. It can be known from FIG. 16 that the antenna 10 has an excellent circuit performance for electromagnetic signals in frequency bands of 0.82 GHz to 0.86 GHz and 1.28 GHz to 1.36 GHz. In addition, the electromagnetic signals in the first frequency band and the second frequency band are reflected by the reflecting bottom housing 12, such that the antenna 10 has directionality to the electromagnetic signals in the first frequency band and the second frequency band. In combination with FIG. 17, an H-plane in FIG. 17 represents directivity of the antenna 10 on an H plane, and an E-plane represents directivity of the antenna 10 on an E plane. It can be known from FIG. 17 that on the H plane, electromagnetic signals in the first frequency band collectively radiate in directions of −68° to 50°, and on the E plane, electromagnetic signals in the first frequency band collectively radiate in directions of −50° to 52°. Thus, the antenna 10 has directionality for the electromagnetic signals in the first frequency band. The H plane is perpendicular to the second direction Y, and the E plane is perpendicular to both the first surface 2211 and the H plane. With reference to FIG. 18, in FIG. 18, an H-plane represents directivity of the antenna 10 on an H plane, and an E-plane represents directivity of the antenna 10 on an E plane. It can be known from FIG. 18 that on the H plane, electromagnetic signals in the second frequency band collectively radiate in directions of −53° to 64°, and on the E plane, electromagnetic signals in the second frequency band collectively radiate in directions of −53° to 55°. Thus, the antenna 10 has directionality for the electromagnetic signals in the second frequency band.
2) In a case of the third frequency band, the second radiating assembly 22 is arranged. The second radiating assembly 22 includes a second dielectric plate 221, a second feed line 222, a first feed network 225, a second feed network 226, a plurality of fifth radiating arms 223, and a plurality of sixth radiating arms 224. The first feed network 225 and the plurality of fifth radiating arms 223 are all arranged on the first surface 2211 of the second dielectric plate 221. The plurality of fifth radiating arms 223 are all connected to the first feed network 225. The second feed network 226 and the plurality of sixth radiating arms 224 are all arranged on the second surface 2212 of the second dielectric plate 221. The plurality of sixth radiating arms 224 are all electrically connected to the second feed network 226. The first feed network 225 is connected to the power dividing assembly 24 by the outer conductor 2222 of the second feed line 222. The second feed network 226 is connected to the power dividing assembly 24 by the inner conductor 2221 of the second feed line 222. Thus, the plurality of fifth radiating arms 223 and the plurality of sixth radiating arms 224 jointly radiate the electromagnetic signal in the third frequency band. It can be known from FIG. 19 that the antenna 10 has an excellent circuit performance for electromagnetic signals in frequency bands of 2.12 GHz to 2.75 GHz. In addition, the electromagnetic signal in the third frequency band is reflected by the reflecting bottom housing 12, such that the antenna 10 has directionality to the electromagnetic signal in the third frequency band. In combination with FIG. 20, an H-plane in FIG. 20 represents directivity of the antenna 10 on an H plane, and an E-plane represents directivity of the antenna 10 on an E plane. It can be known from FIG. 20 that on the H plane, electromagnetic signals in the third frequency band collectively radiate in directions of −44° to 72°, and on the E plane, electromagnetic signals in the third frequency band collectively radiate in directions of −44° to 45°. Thus, the antenna 10 has directionality for the electromagnetic signal in the third frequency band.
3) In a case of the fourth frequency band, the third radiating assembly 23 is arranged. The third radiating assembly 23 includes a third dielectric plate 2301, a third feed line 2302, a third feed network 2305, a fourth feed network 2306, a plurality of seventh radiating arms 2303, and a plurality of eighth radiating arms 2304. The third feed network 2305 and the plurality of seventh radiating arms 2303 are all arranged on the third surface 23011 of the third dielectric plate 2301. The plurality of seventh radiating arms 2303 are all connected to the third feed network 2305. The fourth feed network 2306 and the plurality of eighth radiating arms 2304 are all arranged on the fourth surface 23012 of the third dielectric plate 2301. The plurality of eighth radiating arms 2304 are all electrically connected to the fourth feed network 2306. The third feed network 2305 is connected to the power dividing assembly 24 by the outer conductor 23022 of the third feed line 2302. The fourth feed network 2306 is connected to the power dividing assembly 24 by the inner conductor 23021 of the third feed line 2302. Thus, the plurality of seventh radiating arms 2303 and the plurality of eighth radiating arms 2304 jointly radiate the electromagnetic signal in the fourth frequency band. It can be known from FIG. 21 that the antenna 10 has an excellent circuit performance for electromagnetic signals in frequency bands of 4.80 GHz to 6.09 GHz. In addition, the electromagnetic signal in the fourth frequency band is reflected by the reflecting bottom housing 12, such that the antenna 10 has directionality to the electromagnetic signal in the fourth frequency band. In combination with FIG. 22, an H-plane in FIG. 22 represents directivity of the antenna 10 on an H plane, and an E-plane represents directivity of the antenna 10 on an E plane. It can be known from FIG. 22 that on the H plane, electromagnetic signals in the fourth frequency band collectively radiate in directions of −55° to 55°, and on the E plane, electromagnetic signals in the fourth frequency band collectively radiate in directions of −35° to 60°. Thus, the antenna 10 has directionality for the electromagnetic signals in the fourth frequency band.

In embodiments of the disclosure, the antenna module 2 is mounted in the accommodating cavity 13 jointly formed by the radome 11 and the reflecting bottom housing 12, and a signal is radiated in the direction of the radome 11 by the reflecting bottom housing 12 such that the intensity of the electromagnetic signal on one side of the radome 11 can be enhanced, and the distance of radiating the electromagnetic signal can increased.

The above descriptions show only embodiments of the disclosure and do not limit the patent scope of the disclosure. Equivalent structures or equivalent process changes made by using content of the description and accompanying drawings in the disclosure or directly or indirectly applied to other related technical fields shall all fall within the patent protection scope of the disclosure in a similar way.

1. An antenna, comprising:
a housing comprising a radome and a reflecting bottom housing, wherein the radome and the reflecting bottom housing jointly form an accommodating cavity; and
an antenna module mounted in the accommodating cavity, wherein the antenna module is configured to radiate an electromagnetic signal, and the reflecting bottom housing is configured to reflect the electromagnetic signal radiated by the antenna module, such that the electromagnetic signal radiates in a direction of the radome.

2. The antenna according to claim 1, wherein
the antenna module comprises a first radiating assembly, the first radiating assembly comprises a first dielectric plate, a first feed line, a first radiating arm, and a second radiating arm, the first dielectric plate is accommodated in the accommodating cavity, the first radiating arm and the second radiating arm are both arranged on the first dielectric plate, one end of the first radiating arm is electrically connected to an inner conductor of the first feed line, one end of the second radiating arm is electrically connected to an outer conductor of the first feed line, the other end of the second radiating arm extends in a direction away from the first radiating arm, and the first radiating arm and the second radiating arm are jointly configured to radiate an electromagnetic signal in a first frequency band.

3. The antenna according to claim 2, wherein
the first radiating arm comprises a first straight section and a first gradually-changing section, two ends of the first straight section are connected to the inner conductor of the first feed line and the first gradually-changing section respectively, and a width of the first gradually-changing section gradually increases from one end of the first gradually-changing section close to the first straight section to one end away from the first straight section;
and/or
the second radiating arm comprises a second straight section and a second gradually-changing section, two ends of the second straight section are connected to the outer conductor of the first feed line and the second gradually-changing section respectively, and a width of the second gradually-changing section gradually increases from one end of the second gradually-changing section close to the second straight section to one end away from the second straight section.

4. The antenna according to claim 2, wherein
the first radiating assembly further comprises a third radiating arm and a fourth radiating arm, the third radiating arm and the fourth radiating arm are both arranged on the first dielectric plate, one end of the third radiating arm is electrically connected to the inner conductor of the first feed line, one end of the fourth radiating arm is electrically connected to the outer conductor of the first feed line, the other end of the fourth radiating arm extends in a direction away from the third radiating arm, and the third radiating arm and the fourth radiating arm are jointly configured to radiate an electromagnetic signal in a second frequency band.

5. The antenna according to claim 2, wherein
the antenna module further comprises a second radiating assembly and a power dividing assembly, the first feed line is connected to the power dividing assembly, the second radiating assembly comprises a second dielectric plate, a second feed line, a fifth radiating arm, and a sixth radiating arm, the second dielectric plate is accommodated in the accommodating cavity, the fifth radiating arm and the sixth radiating arm are both arranged on the second dielectric plate, an outer conductor of the second feed line is connected to one end of the fifth radiating arm, an inner conductor of the second feed line is connected to one end of the sixth radiating arm, the second feed line is further connected to the power dividing assembly, and the fifth radiating arm and the sixth radiating arm are jointly configured to radiate an electromagnetic signal in a third frequency band.

6. The antenna according to claim 5, wherein
the fifth radiating arm is in a T shape;
and/or
the sixth radiating arm is in a T shape.

7. The antenna according to claim 5, wherein
a plurality of fifth radiating arms are arranged, the plurality of fifth radiating arms are all arranged on a first surface of the second dielectric plate, the plurality of fifth radiating arms are all electrically connected to the outer conductor of the second feed line, and the first surface faces the reflecting bottom housing;
and/or
a plurality of sixth radiating arms are arranged, the plurality of sixth radiating arms are all arranged on a second surface of the second dielectric plate, the plurality of sixth radiating arms are all electrically connected to the inner conductor of the second feed line, and the second surface faces away from the reflecting bottom housing.

8. The antenna according to claim 5, wherein
the second radiating assembly further comprises a first feed network and a second feed network, the first feed network is configured to be connected to the fifth radiating arm and the outer conductor of the second feed line, the second feed network is configured to be connected to the sixth radiating arm and the inner conductor of the second feed line, the first feed network is arranged on the first surface of the second dielectric plate, the second feed network is arranged on the second surface of the second dielectric plate, the first feed network and the second feed network at least partially overlap in a direction perpendicular to the first surface, the first surface faces the reflecting bottom housing, and the second surface faces away from the reflecting bottom housing.

9. The antenna according to claim 5, wherein
the antenna module further comprises a third radiating assembly, the third radiating assembly comprises a third dielectric plate, a third feed line, a seventh radiating arm, and an eighth radiating arm, the third dielectric plate is accommodated in the accommodating cavity, the seventh radiating arm and the eighth radiating arm are both arranged on the dielectric plate, one end of the seventh radiating arm is electrically connected to an outer conductor of the third feed line, one end of the eighth radiating arm is electrically connected to an inner conductor of the third feed line, the third feed line is further connected to the power dividing assembly, and the seventh radiating arm and the eighth radiating arm are jointly configured to radiate an electromagnetic signal in a fourth frequency band.

10. The antenna according to claim 5, wherein
a plurality of seventh radiating arms are arranged, the plurality of seventh radiating arms are all arranged on a third surface of a third dielectric plate, the plurality of seventh radiating arms are all electrically connected to an outer conductor of a third feed line, and the third surface faces the reflecting bottom housing;
and/or
a plurality of eighth radiating arms are arranged, the plurality of eighth radiating arms are all arranged on a fourth surface of the third dielectric plate, the plurality of eighth radiating arms are all electrically connected to an inner conductor of the third feed line, and the fourth surface faces away from the reflecting bottom housing.

11. The antenna according to claim 9, wherein
the third radiating assembly further comprises a third feed network and a fourth feed network, the third feed network is configured to be connected to the seventh radiating arm and the outer conductor of the second feed line, the fourth feed network is configured to be connected to the eighth radiating arm and the inner conductor of the second feed line, the third feed network is arranged on a third surface of a third dielectric plate, the fourth feed network is arranged on a fourth surface of the third dielectric plate, the third feed network and the fourth feed network at least partially overlap in a direction perpendicular to the third surface, the third surface faces the reflecting bottom housing, and the fourth surface faces away from the reflecting bottom housing.

12. A control device, comprising a control body and the antenna according to any one of claim 1, wherein a housing in the antenna is rotationally connected to the control body, the antenna further comprises a feed bus, one end of the feed bus is connected to the antenna module, the other end of the feed bus is connected to the control body, and the feed bus is configured to transmit an electromagnetic signal between the antenna module and the control body.

13. The control device according to claim 12, further comprising:
a rotary seat, wherein the rotary seat is mounted on the control body, the rotary seat is provided with a first rotary shaft and a second rotary shaft, the first rotary shaft and the second rotary shaft are opposite each other, the first rotary shaft and the second rotary shaft are inserted into the housing, and the housing is capable of rotating around the first rotary shaft and the second rotary shaft.
